(19) United States
(12) Patent Application Publication
(10) Pub. No.: US 2026/0073194 A1
(43) Pub. Date: Mar. 12, 2026

(54) JOINT DECODING OF RESPONSE AND PREDICTED QUERY-RESPONSE PAIRS USING A TOKEN GENERATION NEURAL NETWORK

(71) Applicant: DeepMind Technologies Limited, London (GB)

(72) Inventors: Duc-Hieu Tran, Zurich (CH); Florian Nils Hartmann, Zurich (CH)

(21) Appl. No.: 18/828,313

(22) Filed: Sep. 9, 2024

(51) Int. Cl. G06N 3/0475; G06F 40/30; G06F 40/40; G06N 3/045

(52) U.S. Cl. CPC G06N 3/0475; G06F 40/30; G06F 40/40; G06N 3/045

(57) ABSTRACT

Methods, systems, and apparatus, including computer programs encoded on a computer storage medium, for pre-generating predictions of subsequent queries with corresponding responses relating to a context using a token generation neural network. In one aspect, a system comprises receiving an input comprising a context and a first query related to the context, processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query, providing the first response to the first query for presentation to a user, and caching any of the k predicted query-response pairs.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate a response to a query, e.g., a directive instruction, from a user related to a context and can pre-generate predictions of subsequent queries submitted by the user related to the context with corresponding responses. In this specification, the context is data that provides support or related information for the query, e.g., the context can be text, a book, a document, a video input, an audio input, etc., and the query can relate to the content of the context.

In particular, the system can process an input including the context and the query from the user using a token generation neural network to generate a response to the query and one or more additional query-response pairs. In the case that the system receives an additional query from the user, the system can evaluate whether to return any of the one or more responses, e.g., by matching the additional query to one or more queries of the pre-generated query-response pairs and returning the corresponding relevant responses.

As an example, the token generation neural network can be a language processing neural network, e.g., a large language model or a large multi-modal model, that can generate the response and the predicted query-response pairs. In this case, the system can process a prompt that includes the query and the context as an input using the large language model.

According to a first aspect there is provided receiving an input comprising a context and a first query related to the context for a user, processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query, providing the first response to the first query for presentation to the user, and caching any of the k predicted query-response pairs.

Particular embodiments of the subject matter described in this specification can be implemented so as to realize one or more of the following advantages.

The system of this specification allows for the generation of a response and future queries and responses in a single model call to a token generation neural network. In this context, a single model call refers to a single processing iteration of the query and the context using the token generation neural network. In contrast to having to process the context each time a subsequent query is submitted for a context or maintaining and retrieving activation or query-key-value embeddings for the context, the system can generate the response and pre-generate potential responses in one model call, and then provide the pre-generated responses as needed.

In particular, generating both the response and predicted query-response pairs for a particular context in a single model call reduces the use of computational resources required to provide the follow-up responses. In the case that the system receives a long context, e.g., which can be hundreds of thousands to millions of tokens long, each forward pass of the long context through the token generation neural network requires a large allocation of computational resources, including context transmission and a nontrivial processing time.

More specifically, the system can facilitate efficient response generation for long contexts by processing the long context only once, thereby reducing the use of computational resources and significantly reducing the response latency required to generate additional responses to follow-up queries with respect to repeatedly processing the context. Moreover, only processing the long context once reduces the communication transmission between the query submitter, e.g., a user, and the token generation neural network, thereby meaningfully improving the user experience, e.g., since follow-up responses can be provided after receiving an additional query for the context from the user without the processing of additional model inputs using the token generation neural network.

In addition, in contrast to internal activation caching which limits the model to generating tokens from the exact input received, the system can generate responses for different queries related to the same context through the pre-generation process. Furthermore, the system does not need to maintain a map between contexts and query-key-values, which can require memory-intensive storage, since even slight differences in long contexts can result in the need to store different query-key-values.

Additionally, due to the enhanced processing efficiency of only processing the context once, the system can employ a larger token generation neural network, e.g., a token generation neural network with a larger number of parameters, which can further enhance the processing of a long context. In particular, the system supports model scaling since the computational resources that would have been allocated to the repetitive processing of the context can be used for other purposes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates the processing of a prompt and a subsequent prompt regarding a context using a token generation neural network that does not pre-generate predicted query-response pairs.

FIG. 2 is a system diagram of an example context query-response generation system that can pre-generate predicted query-response pairs for a context.

FIG. 3A depicts an example of receiving an additional query and identifying a response to return from the cached queries using semantic similarity. FIG. 3B is an example of identifying a response to retrieve from a vector database of query-response pairs.

FIG. 4 is a flow diagram of an example process for generating a response to a first query and k predicted query-response pairs using a token generation neural network.

Like reference numbers and designations in the various drawings indicate like elements.

### DETAILED DESCRIPTION

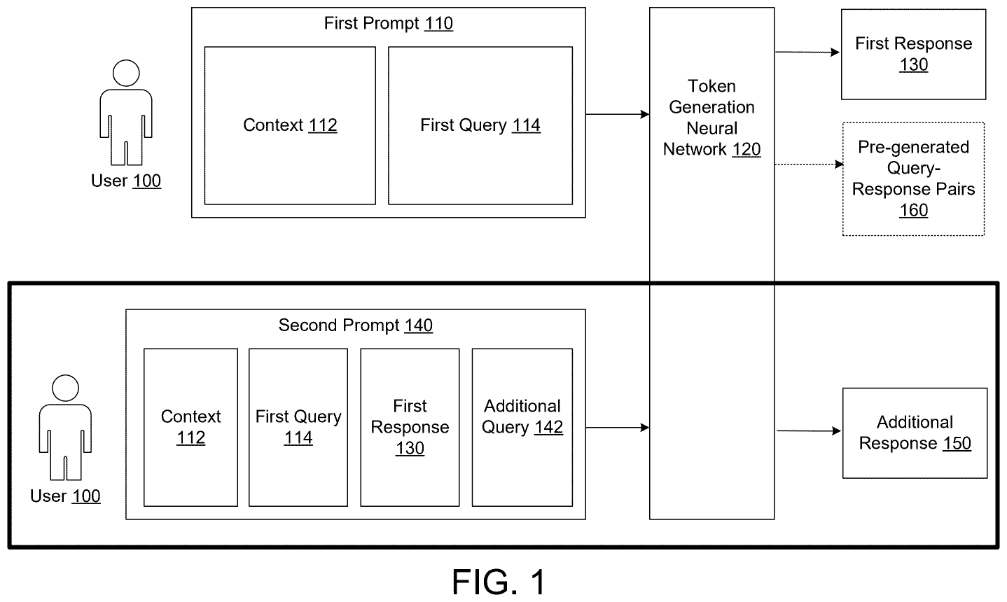

FIG. 1 shows an example of using a token generation neural network to process a prompt related to a context and a subsequent prompt regarding the context. In this case, the token generation neural network is not configured to pre-generate predicted query-response pairs, leading to an additional processing iteration of the long context that can be avoided by configuring the token generation neural network using a context query-response generation system.

In the particular example depicted, the token generation neural network 120 receives a first prompt, e.g., the prompt 110, from a user 100 that includes a context 112 and a first query, e.g., the query 114. In particular, the query 114 can include a directive instruction that relates to the content of the context 112. For example, the query can be a question or statement that relates to the context 112.

For example, the context 112 can be a text, a book, a document, a webpage, etc. As another example, the context 112 can be an image input, an audio input, or a video input. In some cases, the context 112 can include one or more example prompt-response pairs, e.g., that are provided for the purposes of few-shot prompting.

As an example, the user 100 can query the token generation neural network 120 by inputting a direction to “Summarize this news article. ” with a corresponding news article as context, inputting a video clip or audio clip with a question to identify “What are the themes of this media?”, or submitting a document with a list of corresponding text analysis questions to generate respective outputs to each of the questions.

In some cases, the context 112 can be a long context that includes a large amount of data, e.g., a large number of tokens. In particular, a context can be considered long based on the proportion of the context window that is necessary to process the context 112 with respect to the total context window available for processing. In some cases, token generation neural networks can be configured to support long contexts, e.g., contexts of 1-2 million tokens. As an example, multiple books, a movie, or a lengthy legal contract can be considered long contexts by this metric.

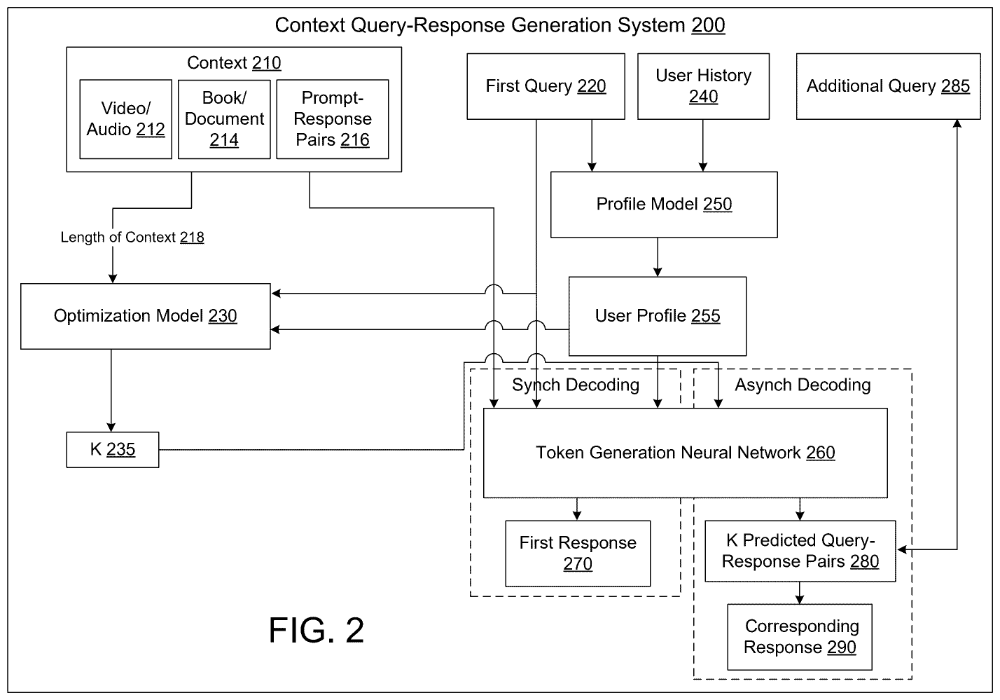

The token generation neural network 120 can have a neural network architecture that is configured to process an input sequence of tokens and trained to perform next element prediction, e.g., to define a likelihood score distribution over a set of next elements. In particular, the neural network can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). For example, the token generation model can be a recurrent neural network (RNN), long short-term memory (LSTM), gated-recurrent unit (GRU), transformer-based model, e.g., encoder-decoder model, encoder-only, or decoder-only model, as will be described with more detail with respect to FIG. 2.

Generally, the user 100 can prompt the token generation neural network 120 with a context by inputting a context together with a query, e.g., the context 112 with the first query 114. The token generation neural network 120 can then process the context and the query together to generate a response, e.g., the first response 130, which can be provided to the user 100, e.g., by way of a user interface.

For example, a system that manages the prompting of the token generation neural network 120 can cache the context 112, the first query 114, and the response 130, e.g., in case they are needed for further processing to provide an additional response 150. In the case that a user 100 has a follow-up query with respect to the context 112, the user 100 can input the follow-up query, e.g., the additional query 142. In the particular example depicted in the solid boxed portion, the token generation neural network 120 can process the second prompt 140, which includes the initial context 112, the first query 114, the first response 130, and the additional query 142, to generate the additional response 150. In particular, in response to a follow-up query, the system can generate the second prompt 140, by combining the second query 142 with the context 112, the first query 114, and the first response 130.

While not depicted in this example, in the case that the user 100 inputs an additional follow-up query, the token generation neural network 120 can process a third prompt that includes the context 112, the second query 114, and the additional response 150, to generate a subsequent response.

In this solid boxed portion, the number of times the context is processed by the token generation neural network 120 is proportional to the number of queries input by the user 100 for the context 112, e.g., the token generation neural network 120 processes the context 112 each time the user 100 has a follow-up question that relates to the context 112. While not depicted in this example, in the case that the user 100 inputs an additional follow-up query, the token generation neural network 120 can process a third prompt that includes the context 112, the second query 114, and the additional response 150, to generate a subsequent response.

This can be computationally inefficient, especially in the case that the context is a long context, which requires a large allocation of computational resources and nontrivial processing time to process. For example, due to this inefficiency, it will be computationally prohibitive to scale up the size, e.g., the number of parameters, of the token generation neural network 120, e.g., thereby decreasing the system's potential processing capabilities due to the need to accommodate the repeat processing of the context.

Instead of repetitively processing the same context 112, the token generation neural network 120 can be configured to jointly decode the first response 130 for the query 114 and pre-generate predicted query-response pairs 160 that the user may ask in the future given the same context 112. By pre-generating the query-response pairs 160, the system can more efficiently use the context 210 with respect to the boxed portion. In particular, with this prediction and pre-generation process, the token generation neural network 120 can process the context 210 only once, thereby meaningfully improving the user experience by preparing responses, e.g., the response 290, in advance, and significantly reducing the response latency and the use of computational resources required to generate additional responses to follow-up queries with respect to repeatedly processing the context 112.

Furthermore, configuring the token generation neural network to pre-generate the predicted query-response pairs 160 can improve upon existing caching methods that circumvent the need for repetitively processing the same context 112, but require the maintenance of mappings between contexts and internal activation or query-key-value embeddings. In particular, caching internal activations or query-key-value embeddings can be memory intensive, since even slight differences in contexts can result in the need to store different embeddings. In addition, it can be difficult to identify which cached activation or query-key-value are applicable or useful to a new query, e.g., after receiving the additional query 142, and whether or not to remove previously cached activation or query-key-values.

FIG. 2 shows an example context query-response generation system 200. The context query-response generation system 200 is an example of a system implemented as computer programs on one or more computers in one or more locations in which the systems, components, and techniques described below are implemented.

More specifically, the system 200 can use a token generation neural network 260 that has been configured to generate tokens for a first response 270 to a first query 220 related to a context 210 and k predicted query-response pairs 280 that can be used to generate a corresponding response 290 for an additional received query 285, as will be described in more detail below.

Similarly to the token generation neural network 120 of FIG. 1, the token generation neural network 260 can have a neural network architecture that is configured to process an input sequence of tokens pertaining to the first query 220 and the context 210 and trained to perform next element prediction, e.g., to define a likelihood score distribution over a set of next elements. In particular, the neural network can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the token generation neural network 260 can be a language processing neural network. A language processing neural network is an auto-regressive neural network that is configured to process the contents of an input and trained to perform next element prediction. More specifically, the token generation neural network 260 can auto-regressively generate an output sequence of tokens, e.g., by generating each token in the output sequence of tokens by conditioning on a current input sequence that includes any tokens that precede the particular token in the output sequence.

In particular, the token generation neural network 260 can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

In some cases, the token generation neural network 260 can be a long context large language model that is configured to process a large amount of data, e.g., using an extended context window to accommodate a large number of tokens, e.g., tens of thousands to hundreds of millions. For example, each word or character in a textual input can be considered a token. As another example, a textual input can be encoded into a word piece or byte tokens, e.g., elements that merge the most frequently appearing character sequences.

Furthermore, the token generation neural network 260 can be a multi-modal model, e.g., a visual language model (VLM) that can be configured to process the query 220, e.g., in a text or audio modality, and an image or sequence of images in a video, e.g., the context 210, to generate an intermediate representation of the image and perform an image processing task. For example, the token generation neural network 260 can be a contrastive language-image pre-training (CLIP) model, a vision transformer (ViT), a unified image-to-image translation (UNIT) model, or an attention generative adversarial network (AttnGAN).

As an example, the image processing task can involve generating an output that requires reasoning, e.g., spatio-temporal reasoning, to respond to a natural language query input, e.g., relating to a moving image (video). For example, such a query may require predictive reasoning (“what will happen next”), counterfactual reasoning (“what would happen in a different circumstance”), explanatory reasoning (“why did something happen”), or causal reasoning generally. For example, the image representation can be used to detect objects in the video frames and provide information relating to the detected objects in response to a query, e.g., a request for a prediction of a future event or state relating to one or more of the objects (e.g., “will objects X and Y collide?”), or a request for conditional or counterfactual information relating to one or more of the objects (e.g., “what event would [not] happen if object X is modified, moved or absent?”), or a request for analysis of the video frames to determine a property or characteristic of one or more of the objects (e.g., “how many objects of type Z are moving?”). The output may, for example, be in the form of a yes/no answer, or may define a probability distribution over a set of possible answers; or the response may define the location of an object. Such a base network can be used to predict whether or not two objects will collide, or how this may be avoided. The output may be used e.g., to provide a warning, to control motion of one or more of the objects, or both.

In the case that the token generation neural network 260 is implemented as a long context large language model, the system 200 can accommodate a large token input. For example, in this case, the token generation neural network 260 can process an equivalent of 700,000 words, e.g., a series of books, or 1 hour of video, using 1 million tokens. As an example, the token generation neural network 120 can include architecture modifications to assist in the processing of the larger amount of data, e.g., a modified attention mechanism, adaptive memory management, or the incorporation of a hierarchical structure, e.g., in order to perform segment-level processing, recursive processing, multi-scale processing, or chunking.

In particular, the system 200 can receive a first query 220 related to a context 210 from a user. In some cases, the context 210 can be a long context, e.g., that includes a large amount of data, e.g., a large number of context tokens. For example, the context 210 can include video/audio 212 content, a book/document 214, or a set of prompt-response pairs 216, e.g., in a few-shot prompting example in which a user inputs a set of example prompt-response pairs to finetune the token generation neural network 260.

Optionally, the system 200 can also receive user history 240 for the user, e.g., auxiliary data characterizing the user that provides information that can be used to better predict additional queries the user might be interested in for a given context 210. As an example, the user history 240 can include behavior data characterizing the user's prior interactions with the token generation neural network 260, e.g., one or more prior queries processed by the token generation neural network 260 for the user. As another example, the user history 240 can include software application data from the application the user is inputting queries into the system 200 with or one or more related software applications. As yet another example, the user history 240 can include screen capture data from the user device the user is using to input the query 220 into the system 200.

In the case that the system 200 receives a user history 240, the system 200 can process the first query 220 and the user history 240 using a profile model 250 to generate a user profile 255, e.g., user data features that can be used to characterize the user. The system 200 can then use the user profile 255 to generate the first response 270 and the k predicted query-response pairs 280.

The profile model 250 can have any appropriate machine learning architecture, e.g., a neural network, that can be configured to process the first query 220 and the user history 240 and embed the inputs in an embedding space, e.g., a profile embedding space. In particular, the profile model 250 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the profile model 250 can be implemented as a lightweight, e.g., smaller model based on the number of parameters, than the token generation neural network 260. In some cases, the profile model 250 can be located on the user device that the user is using to submit queries to the system 200.

In this case, the system 200 can use the user profile 255 to determine the number k 235 of follow-up query-response pairs that should be generated for the context 210 based on the first query 220. In the particular example depicted, the system 200 can process the user profile 255, the first query 220, and the length of the context 218 using an optimization model 230 to determine the number k 235. As an example, the system 200 can determine the length of the context 218 based on a file size, a number of words, a length of time, or another measure of the number of tokens that will need to be generated to represent the context 210.

In the case that the system 200 does not receive a user history 240, the system 200 can process the first query 220 using a different optimization model that has been configured to determine the number k 235 using the first query 220. As another example, the system 220 can be configured with a predefined number k 235, e.g., the system 220 can generate k predicted query-response pairs regardless of the contents of the first query 220.

The optimization model 230 can have any appropriate machine learning architecture, e.g., a neural network, that can be configured to process the user profile 255, the first query 220, and the length of the context 218 to generate the number k 235. For example, the optimization model 230 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In particular, the optimization model 230 can have been trained to optimize the value of k 235 based on previous user queries for a set of example contexts. More specifically, for some queries and contexts, a high value of k 235 should be generated, while, for others, especially if the context 210 is short, a low value of k 235 should be generated since it is not likely more than a few follow-up queries will be received, e.g., based on the user profile 255.

The system 200 can process the first query 220, the context 210, the user profile 255, and the number k 235 using the token generation neural network 260. In particular, the system 200 can autoregressively generate a sequence of output tokens that includes the first response 270 and the k predicted query-response pairs 280. For example, the sequence of output tokens can include one or more of text, image, video or audio modality output tokens that pertain to the first response 270 and the k predicted query-response pairs 280.

More specifically, the system 200 can generate tokens pertaining to a set of k predicted queries that the user may subsequently ask for the context 210, e.g., based on the user profile 255 and the context 210, and corresponding responses for the predicted queries. In particular, the system 200 can pre-generate the k predicted query-response pairs 280 on the first pass of the context 210 through the token generation neural network 260, thereby saving computational resources by preventing the need to repeatedly process the context 210 for each follow-up query received that relates to the context 210.

The system 200 can process the context 210, the first query 220, and the user profile 255 using the token generation neural network 260 to generate the first response 270 in a synchronous decoding mode. The system 200 can continue to generate tokens based on the number k 235, the user profile 255, and the context 210 in an asynchronous decoding mode. More specifically, the system 200 can generate the k predicted query-response pairs 280 either in parallel with the first response 270 or after providing the first response to the user, and can decode the k predicted query-response pairs 280 after providing the first response 270 to the user.

In this context, a decoding mode refers to the manner by which the token generation neural network 260 decodes the sequence of output tokens. In particular, the system 200 can use the token generation neural network 260 in a synchronous decoding mode to generate and decode the tokens of the first response 270, e.g., which can be sequentially provided to a user as a next step after or as the tokens of the first response 270 are decoded, e.g., the system 200 can use a streaming mode of decoding, e.g., to display the response as it is decoded.

In the case that k 235 is not zero, the system 200 can decode the tokens for the k predicted query-response pairs 280 in an asynchronous decoding mode, e.g., after the first response 270 has been provided to the user, e.g., by way of a user interface For example, this can allow for the delayed decoding of the tokens of the k predicted query-response pairs 280, e.g., decoding that happens independently of the decoding used to provide the first response 270 to a user. In particular, the system 200 can decode the tokens of k predicted query-response pairs 280 in response to a user action, as will be described below. In the case that k is zero, the token generation neural network 260 can cease generating output tokens after generating the output tokens that pertain to the first response 270.

In some cases, the system 200 can decode and cache the k predicted query-response pairs 280 and provide the queries to the user, e.g., by way of a user interface, for selection, e.g., after providing the first response 270. For example, the system 200 can provide a user interface that can display the possible follow-up queries for the user to select, e.g., as a grid or list. In this case, the system 200 can provide the corresponding response 290 in response to an indication of a selection of an additional query 285 by the user.

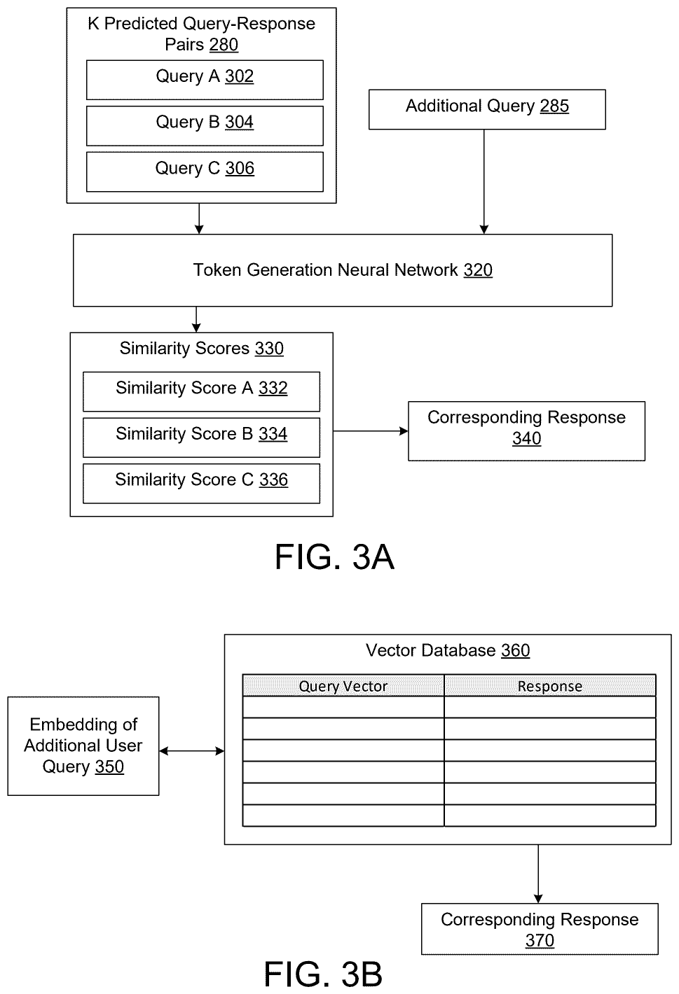

In other cases, the system 200 can wait to receive a follow-up query from the user, e.g., an additional query 285, before decoding and caching the k predicted query-response pairs 280. In this case, the system 200 can evaluate whether the query relates to one or more of the predicted k predicted query-response pairs 280. For example, the system 200 can use exact or semantic matching to determine whether the additional query 285 can be sufficiently answered with one or more of the pre-generated k predicted query-response pairs 280. An example of evaluating whether the additional query can be answered using the pre-generated query-response pairs will be described in more detail with respect to FIGS. 3A and 3B. In this case, the system 200 can provide the corresponding response 290 in response to determining that the additional query 285 relates to one or more of the k predicted query-response pairs 280.

In particular, after determining that one or more of the k predicted query-response pairs 280 can be used to generate a response to the additional query 285, the system 200 can provide the corresponding response 290 to the additional query 285 without processing any additional inputs using the token generation neural network 260. By not processing the context 210 each time an additional query 285 is received, the system 200 reduces the computational resources necessary to provide the corresponding response 290 and significantly speeds up how quickly the user receives a response for a follow-up query with respect to a particular context.

In some cases, the system 200 can maintain a user interaction database. In this case, the system 200 can record whether the user input an additional query for the context 210, and if so, whether it was answered using one or more of the k predicted query-response pairs in the user interaction database.

As an example, recording the interaction data can provide a feedback signal to the system 200 indicating which queries the user selected and which ones the user would have preferred. Furthermore, the system 200 can record whether the user stopped submitting queries for the context 210, e.g., indicating that the user was not interested in any follow-up queries for a given context.

For example, the interaction data, e.g., interaction data stored in the user interaction database, can be used to finetune or further train the token generation neural network 260, the profile model 250, or both. In particular, the system 200 or another system can train the token generation neural network 260, the profile model 230 or both using the interaction data. For example, the system 200 can organize previous queries that multiple users asked for a number of contexts, and can train the profile model 250 to generate the user profile of each user and the token generation neural network 260 to generate the k predicted query-response pairs 280 based on the subsequent queries that were received and recorded in the interaction data for each user.

In some cases, the optimization model 230 can be jointly trained with the token generation neural network 260 and the profile model 250, e.g., using the interaction data to determine the value of k. In other cases, the optimization model 230 can be trained separately to generate a value of k based on the recorded number of follow-up queries a given user inputs for a particular context.

In the case that the system receives an additional query, the system can determine whether the additional query of the user relates to one or more of the predicted queries in the k predicted query-response pairs. For example, the context query-response generation system 200 can evaluate whether the additional query can be answered using the pre-generated query-response pairs using a semantic similarity score, e.g., as depicted in FIG. 3A, or a vector database, e.g., as depicted in FIG. 3B.

In particular, FIG. 3A demonstrates how the system can process a set of query pairs, e.g., as part of a prompt to determine a measure of semantic similarity using a token generation neural network 320. More specifically, the measure of semantic similarity can be a similarity score that indicates the degree to which the queries in the query pair share the same meaning and context, e.g., whether the queries sharing the same content, even if they use different words.

For example, the system can process a query pair for each of the k predicted query-response pairs 280, e.g., the query A 302 and the additional query 285, the query B 304 and the additional query 285, the query C 306 and the additional query 285, etc., with an instruction to determine a similarity score for the two queries in the query set.

As an example, the token generation neural network 320 can have a neural network architecture that is configured to process an input sequence of tokens and trained to perform next element prediction, e.g., to define a likelihood score distribution over a set of next elements. In particular, the token generation model can be a recurrent neural network (RNN), long short-term memory (LSTM), gated-recurrent unit (GRU), encoder-decoder transformer, or large language model.

In some cases, the token generation neural network 320 can be the same model as the token generation neural network 260. In other cases, the token generation neural network 320 is a different model.

More specifically, the token generation neural network 320 can generate the similarity scores 330, e.g., the similarity score A 332 for the query pair of A 302 and the additional query 285, the similarity score B 334 for the query pair of the query B 304 and the additional query 285, the similarity score C 336 for the query pair of the query C 306 and the additional query 285. As an example, the system can then compare each of the similarity scores 330 to a threshold, e.g., a threshold value, to determine whether the additional query relates to any of the predicted queries 302, 304, or 306.

In the case that the system determines that one of the predicted queries 302, 304, and 306 relate to the additional query 285, the system can provide the corresponding response to the user. For example, in the case that the similarity score A 332 is 3, the similarity score B 334 is 5, the similarity score C 336 is 8, and the threshold value is 6, the system can provide the corresponding response 340 for query B 334 to the user.

As another example, in the case that more than one of the queries have a similarity score above the threshold value, e.g., the similarity score B 334 is 7 and the similarity score C 336 is 8, the system can combine the corresponding responses to the query B 304 and the query C 306 as the corresponding response 340. In some cases, the system can concatenate the responses to generate the corresponding response 340. In other cases, the system can process the responses, e.g., using a large language model, to generate a synthesized response as the corresponding response 240.

FIG. 3B illustrates another example of identifying a response to an additional query. In this case, the system can determine whether the additional query relates to one or more of the predicted queries in the k predicted query-response pairs using a vector database 360.

For example, the system can maintain a vector database 360 for each of the predicted k query-response pairs, e.g., the system can decode and store a query vector for each query, e.g., an embedding of the predicted query, with a corresponding response in the vector database 360. In particular, the system can embed each of the queries using an embedding model or an embedding layer of a neural network configured to generate the query vectors for each query.

In particular, the embedding model can have any appropriate machine learning architecture, e.g., a neural network, that can be configured to process and embed the query in an query embedding space. In particular, the embedding model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). Likewise, the embedding layer can be implemented as a layer of any appropriate type.

The system can embed the additional user query, e.g., using the embedding model used to embed each of the query vectors, and can compare the embedding of the additional user query vector 350 to each of the query vectors in the vector database 360 to identify a relevant query vector in the database. In particular, the system can evaluate a measure of similarity between the embeddings, and can retrieve the corresponding response 370 for the first query vector according to the measure of similarity, e.g., by comparing the measure of similarity to a threshold value as described with respect to FIG. 3A.

For example, the system can compute a cosine similarity, a dot product, or a Pearson correlation coefficient between the embedding of the additional query 350 and each query vector in the database 360 as the measure of similarity. As another example, the system can compute a Euclidean or Manhattan distance between the embedding of the additional query 350 and each query vector in the database 360 as the measure of similarity.

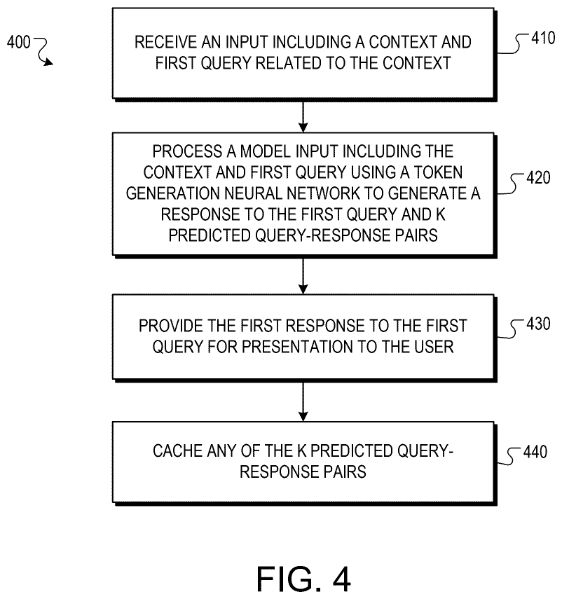

FIG. 4 is a flow diagram of an example process for generating a response to a first query and k predicted query-response pairs using a token generation neural network. For convenience, the process 400 will be described as being performed by a system of one or more computers located in one or more locations. For example, a context query-response generation system, e.g., the context query-response generation system 200 of FIG. 2, appropriately programmed in accordance with this specification, can perform the process 400.

The system can receive an input including a context and a first query related to the context (step 410). For example, the system can receive the context and the query as part of a prompt. In particular, the query can relate to the content of the context. For example, the context can be a text, a book, a document, a webpage, etc. As another example, the context can be an image input, an audio input, or a video input. In some cases, the context can include one or more example prompt-response pairs, e.g., that are provided for the purposes of few-shot prompting.

The system can process a model input including the context and first query using a token generation neural network to generate a response to the first query and k predicted query-response pairs (step 420). In particular, each predicted query-response pair can include a prediction of a subsequent query submitted by the user related to the context query and a corresponding response to the predicted query. For example, the system can determine a value of k based on a user profile for the user and the context, and can autoregressively generate, e.g., by processing the model input using the token generation neural network, a sequence of output tokens including the first response and the k predicted query-response pairs.

In some cases, the token generation neural network can be configured to support a long context, e.g., a context that includes a large amount of data, e.g., 1-2 million tokens. As an example, each word or character in a textual input can be a token. In particular, having a large input context enables the token generation neural network to process a lot of information, e.g., a series of books or a movie.

In particular, the token generation neural network can have a neural network architecture that is configured to process an input sequence of tokens and trained to perform next element prediction, e.g., to define a likelihood score distribution over a set of next elements. As an example, the token generation neural network can be a large language model or a vision language model that is configured to generate a sequence of output tokens. In this case, the sequence of output tokens can include one or more of text, image, video, or audio modality output tokens.

For example, the system can process auxiliary data characterizing the user, e.g., one or more prior queries processed by the token generation neural network for the user, and the first query using a profile machine learning model to generate a user profile for the user. The system can then determine the value of k by processing an input that includes the user profile and the context using a machine learning model to generate the value of k. In some cases, the system can additionally process a measure of size of the context as input to the machine learning model. In particular, the machine learning model can have been trained to optimize the value of k based on previous user queries for a set of contexts. In the case that the value of k is zero, the system can cease generating output tokens after the sequence of output tokens pertaining to the first response has been generated.

The system can provide the first response to the first query to the user (step 430), e.g., for presentation. For example, the system can decode the sequence of output tokens that pertain to the first response and can provide the first response to the user by way of a user interface. For example, the system can use a synchronous decoding mode, e.g., stream decoding, to provide the first response to the user.

The system can cache any of the k predicted query-response pairs (step 440). For example, the system can use an asynchronous decoding mode to decode the k predicted query-response pairs independently of the first response and can maintain or store the k predicted query-response pairs, e.g., in case they are needed to answer an additional query of the user that relates to the context. In particular, the system can decode the tokens of the first response as they are generated, and can decode the tokens for the predicted query-response pairs, e.g., in response to a user action. More specifically, by caching the k predicted query-response pairs, the system can provide a corresponding response to an additional query of the user without processing any additional model inputs using the token generation neural network, thereby decreasing response latency.

In some cases, the system can receive an additional query relating to the context from the user and can determine whether the additional query matches one or more of the predicted queries in the k predicted query-response pairs. In this case, in response to determining that the additional query matches one or more of the predicted queries, the system can provide one or more responses from the cached query-response pairs that correspond with the one or more matched predicted queries, e.g., for presentation to the user by way of a user interface.

For example, the system can provide one or more of the predicted queries of the k predicted query-response pairs for presentation to the user by way of a user interface, e.g., as a grid or list of suggested queries, for selection and can receive an indication of selection of a predicted query by way of the user interface as the additional query from the user. In particular, in response to the indication of selection, the system can provide the corresponding response of the selected predicted query to the user for presentation by way of the user interface.

As another example, the system can receive the additional query from the user relating to the context and can determine whether the additional query of the user relates to one or more of the predicted queries in the k predicted query-response pairs. In response to determining that the additional query relates to one or more of the predicted queries, the system can provide the corresponding response of the one or more predicted queries to the user for presentation. In particular, in the case that the system matches the additional query to one of the predicted queries, the system can provide the response for presentation to the user from the cached query-response pair that corresponds with the matched predicted query, e.g., by way of a user interface.

In some cases, the system can use semantic matching to determine whether the additional query of the user relates to one or more of the predicted queries, e.g., the system can use semantic matching to determine respective measures of similarity for the additional query and each of the queries in the k predicted query-response pairs and can determine whether one or more of the respective measures of similarity satisfies a threshold criterion indicating that the additional query relates to the predicted query.

For example, the system can process a set of query pairs including the additional query and each of the predicted queries of the k predicted query-response pairs with a prompt to determine the measure of semantic similarity using a second token generation neural network. In some cases, the system can use the token generation neural network of step 420 as the second token generation neural network. As another example, the system can store a respective query vector, e.g., an embedding of the predicted query, with the corresponding response for each of the k predicted query-response pairs in a vector database and can identify a query vector in the database based on a measure of similarity between an embedding of the additional query and the query vector. In this case, the system can retrieve the corresponding response for the identified query vector.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving an input comprising a context and a first query related to the context for a user;
processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query;
providing the first response to the first query for presentation to the user; and
caching any of the k predicted query-response pairs.

Embodiment 2 is the method of embodiment 1, further comprising:
receiving an additional query relating to the context from the user;
determining that the additional query matches one or more of the predicted queries in the k predicted query-response pairs; and
in response to determining that the additional query matches one or more of the predicted queries, providing, for presentation to the user, one or more responses from the cached query-response pairs that correspond with the one or more matched predicted queries.

Embodiment 3 is the method of any one of embodiments 1-2, wherein providing the response from the query-response pair comprises providing the response without processing any additional model inputs using the token generation neural network.

Embodiment 4 is the method of any one of embodiments 1-3, further comprising:
processing auxiliary data characterizing the user and the first query using a profile machine learning model to generate a user profile for the user.

Embodiment 5 is the method of embodiment 4, wherein the auxiliary data comprises one or more prior queries processed by the token generation neural network for the user.

Embodiment 6 is the method of any one of embodiments 4-5, further comprising determining a value of k based on the user profile and the context.

Embodiment 7 is the method of embodiment 6, wherein determining the value of k comprises processing an input comprising the user profile and the context using a machine learning model to generate the value of k.

Embodiment 8 is the method of embodiment 7, wherein the input further comprises a measure of size of the context.

Embodiment 9 is the method of any one of embodiments 7-8, wherein the machine learning model has been trained by operations comprising optimizing the value of k based on previous user queries for a set of contexts.

Embodiment 10 is the method of any one of embodiments 1-9, wherein processing the model input using the token generation neural network to generate the first response to the first query and the k predicted query-response pairs comprises:
autoregressively generating, by processing the model input using the token generation neural network, a sequence of output tokens comprising the first response and the k predicted query-response pairs.

Embodiment 11 is the method of embodiment 10, wherein the sequence of output tokens comprises one or more of text, image, video, or audio modality output tokens.

Embodiment 12 is the method of any one of embodiments 10-11, further comprising decoding the sequence of output tokens.

Embodiment 13 is the method of any one of embodiments 1-12, wherein providing the first response to the first query for presentation to the user comprises providing the first response to the user by way of a user interface.

Embodiment 14 is the method of any one of embodiments 2-13, wherein receiving the additional query relating to the context from the user comprises:
providing one or more of the predicted queries of the k predicted query-response pairs for presentation to the user by way of a user interface for selection;
receiving an indication of selection of a predicted query by way of the user interface as the additional query from the user; and
in response to the indication of selection, providing the corresponding response of the selected predicted query to the user for presentation by way of the user interface.

Embodiment 15 is the method of any one of embodiments 2-13, wherein receiving the additional query relating to the context from the user comprises:
receiving the additional query from the user relating to the context;
determining whether the additional query of the user relates to one or more of the predicted queries in the k predicted query-response pairs; and
in response to determining that the additional query relates to one or more of the predicted queries, providing the corresponding response of the one or more predicted queries to the user for presentation.

Embodiment 16 is the method of embodiment 15, wherein determining whether the additional query of the user relates to one or more of the predicted queries in the k predicted query-response pairs comprises:
using semantic matching to determine respective measures of similarity for the additional query and each of the queries in the k predicted query-response pairs; and
determining whether one or more of the respective measures of similarity satisfies a threshold criterion indicating that the additional query relates to the predicted query.

Embodiment 17 is the method of embodiment 16, wherein using semantic matching to determine respective measures of similarity comprises processing a set of query pairs, wherein each query pair comprises the additional query and each of the predicted queries of the k predicted query-response pairs, with a prompt to determine the measure of semantic similarity for each query pair using a second token generation neural network.

Embodiment 18 is the method of any one of embodiments 16-17, further comprising, for each of the k predicted query-response pairs, storing a respective query vector with corresponding response in a vector database, wherein each respective query vector is an embedding of the predicted query of the predicted query-response pair, and wherein using semantic matching comprises:
identifying a first query vector in the database based on a measure of similarity between an embedding of the additional query and the query vector; and
retrieving the corresponding response for the first query vector.

Embodiment 19 is the method of any of the preceding embodiments, wherein the token generation neural network is a large language model.

Embodiment 20 is the method of any of the preceding embodiments, wherein the token generation neural network is a vision language model.

Embodiment 21 is the method of any of the preceding embodiments, wherein the token generation neural network has been trained by operations comprising:
obtaining a set of training examples, wherein each training example comprises: (i) a training model input comprising the context and the first query of the user, and (ii) k subsequent query-response pairs for the context; and
training the token generation neural network on the set of training examples.

Embodiment 22 is the method of embodiment 21, wherein obtaining the set of training examples comprises generating the set of training examples by associating received first queries for the context with any received additional queries for the context from the user.

Embodiment 23 is the method of any of embodiments 4-22, wherein the token generation neural network and the profile machine learning model have been jointly trained by operations comprising:
obtaining a set of training examples, wherein each training example comprises: (i) a training model input comprising the context, the first query of the user, auxiliary data characterizing the user, and (ii) k subsequent query-response pairs for the context; and
training the token generation neural network and the profile machine learning model on the set of training examples.

Embodiment 24 is the method of embodiment 23, wherein determining the value of k comprises processing an input comprising the user profile and the context using a machine learning model to generate the value of k, and wherein the operations further comprise:
training the token generation neural network, the profile machine learning model, and the machine learning model on the set of training examples.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for:
receiving an input comprising a context and a first query related to the context for a user;
processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query;
providing the first response to the first query for presentation to the user; and
caching any of the k predicted query-response pairs.

2. The method of claim 1, further comprising:
receiving an additional query relating to the context from the user;
determining that the additional query matches one or more of the predicted queries in the k predicted query-response pairs; and
in response to determining that the additional query matches one or more of the predicted queries, providing, for presentation to the user, one or more responses from the cached query-response pairs that correspond with the one or more matched predicted queries.

3. The method of claim 2, wherein providing the response from the query-response pair comprises providing the response without processing any additional model inputs using the token generation neural network.

4. The method of claim 1, further comprising:
processing auxiliary data characterizing the user and the first query using a profile machine learning model to generate a user profile for the user.

5. The method of claim 4, wherein the auxiliary data comprises one or more prior queries processed by the token generation neural network for the user.

6. The method of claim 4, further comprising determining a value of k based on the user profile and the context.

7. The method of claim 6, wherein determining the value of k comprises processing an input comprising the user profile and the context using a machine learning model to generate the value of k.

8. The method of claim 7, wherein the input further comprises a measure of size of the context.

9. The method of claim 7, wherein the machine learning model has been trained by operations comprising optimizing the value of k based on previous user queries for a set of contexts.

10. The method of claim 1, wherein processing the model input using the token generation neural network to generate the first response to the first query and the k predicted query-response pairs comprises:
autoregressively generating, by processing the model input using the token generation neural network, a sequence of output tokens comprising the first response and the k predicted query-response pairs.

11. The method of claim 10, wherein the sequence of output tokens comprises one or more of text, image, video, or audio modality output tokens.

12. The method of claim 10, further comprising decoding the sequence of output tokens.

13. The method of claim 1, wherein providing the first response to the first query for presentation to the user comprises providing the first response to the user by way of a user interface.

14. The method of claim 2, wherein receiving the additional query relating to the context from the user comprises:
providing one or more of the predicted queries of the k predicted query-response pairs for presentation to the user by way of a user interface for selection;
receiving an indication of selection of a predicted query by way of the user interface as the additional query from the user; and
in response to the indication of selection, providing the corresponding response of the selected predicted query to the user for presentation by way of the user interface.

15. The method of claim 2, wherein receiving the additional query relating to the context from the user comprises:
receiving the additional query from the user relating to the context;
determining whether the additional query of the user relates to one or more of the predicted queries in the k predicted query-response pairs; and
in response to determining that the additional query relates to one or more of the predicted queries, providing the corresponding response of the one or more predicted queries to the user for presentation.

16. The method of claim 15, wherein determining whether the additional query of the user relates to one or more of the predicted queries in the k predicted query-response pairs comprises:
using semantic matching to determine respective measures of similarity for the additional query and each of the queries in the k predicted query-response pairs; and
determining whether one or more of the respective measures of similarity satisfies a threshold criterion indicating that the additional query relates to the predicted query.

17. The method of claim 16, wherein using semantic matching to determine respective measures of similarity comprises processing a set of query pairs, wherein each query pair comprises the additional query and each of the predicted queries of the k predicted query-response pairs, with a prompt to determine the measure of semantic similarity for each query pair using a second token generation neural network.

18. The method of claim 16, further comprising, for each of the k predicted query-response pairs, storing a respective query vector with corresponding response in a vector database, wherein each respective query vector is an embedding of the predicted query of the predicted query-response pair, and wherein using semantic matching comprises:
identifying a first query vector in the database based on a measure of similarity between an embedding of the additional query and the query vector; and
retrieving the corresponding response for the first query vector.

19. The method of claim 1, wherein the token generation neural network is a large language model.

20. The method of claim 1, wherein the token generation neural network is a vision language model.

21. The method of claim 1, wherein the token generation neural network has been trained by operations comprising:
obtaining a set of training examples, wherein each training example comprises: (i) a training model input comprising the context and the first query of the user, and (ii) k subsequent query-response pairs for the context; and
training the token generation neural network on the set of training examples.

22. The method of claim 21, wherein obtaining the set of training examples comprises generating the set of training examples by associating received first queries for the context with any received additional queries for the context from the user.

23. The method of claim 4, wherein the token generation neural network and the profile machine learning model have been jointly trained by operations comprising:
obtaining a set of training examples, wherein each training example comprises: (i) a training model input comprising the context, the first query of the user, auxiliary data characterizing the user, and (ii) k subsequent query-response pairs for the context; and
training the token generation neural network and the profile machine learning model on the set of training examples.

24. The method of claim 23, wherein determining the value of k comprises processing an input comprising the user profile and the context using a machine learning model to generate the value of k, and wherein the operations further comprise:
training the token generation neural network, the profile machine learning model, and the machine learning model on the set of training examples.

25. A system comprising one or more computers and one or more storage devices storing instructions that are operable, when executed by the one or more computers, to cause the one or more computers to perform operations comprising:
receiving an input comprising a context and a first query related to the context for a user;
processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query;
providing the first response to the first query for presentation to the user; and
caching any of the k predicted query-response pairs.

26. A computer storage medium encoded with a computer program, the program comprising instructions that are operable, when executed by data processing apparatus, to cause the data processing apparatus to perform operations comprising:
receiving an input comprising a context and a first query related to the context for a user;
processing a model input comprising the context and first query using a token generation neural network to generate a first response to the first query and k predicted query-response pairs, wherein each predicted query-response pair comprises (i) a predicted query that is a prediction of a subsequent query submitted by the user related to the context query and (ii) a corresponding response to the predicted query;
providing the first response to the first query for presentation to the user; and
caching any of the k predicted query-response pairs.
